(19) United States
(12) Patent Application Publication
(10) Pub. No.: US 2004/0201712 A1
(43) Pub. Date: Oct. 14, 2004

(54) Image forming apparatus

(75) Inventor: Chih-Hsien Chung, Hsi-Chih City (TW)

Correspondence Address: Richard P. Berg, Esq., LADAS & PARRY, Suite 2100, 5670 Wilshire Boulevard, Los Angeles, CA, 90036-5679, US

(73) Assignee: Acer Communications and Multimedia Inc.

(21) Appl. No.: 09/905,790

(22) Filed: Jul. 13, 2001

(30) Foreign Application Priority Data
Feb. 19, 2001 (TW) 90202413

(51) Int. Cl. H04N 5/225

(52) U.S. Cl. 348/211.99

(57) ABSTRACT

The invention discloses an image forming apparatus comprising an interface unit outputting a control signal in a predetermined format to an output unit in accordance with a sensing signal from a sensor; an image capturing unit for capturing image; and a driving unit detachably coupled to the interface unit, wherein the driving unit having an input unit receiving the control signal for driving the image capturing unit in accordance with the control signal. The sensor of the image forming apparatus is changeable, and can be any device to generate the sensing signal with correspondence to the environmental conditions.

### BACKGROUND OF THE INVENTION

1. Field of the Invention

The present invention relates to an image forming apparatus, especially relates to a modular automated image forming apparatus with a changeable sensor therein.

2. Description of the Related Art

Occasionally, automated photograph technology is needed in an image capturing apparatus such as a video camera or a photo camera in order to obtain desired photographs with preferred environmental conditions. In a physical change process experiment in laboratory, for example, it is necessary to sense the exact time point while the change occurs to the specific experimental material. Another example of application of automated photography is in the field of wild animal observation. The application of automated photography in wild animal observation ensures cameraman safety and captures image of the animals.

To achieve automated photography, a device detecting environmental conditions and producing signals corresponding to the environmental conditions is needed; generally the device can be referred to as a sensor. There are various kinds of sensors used in image capturing, such as pressure sensors, humidity sensors, chemo-sensors and magnetic sensors which are mostly used in laboratory. In addition, there are audiosensors, ultra red ray sensors, timers and photoelectric cells, and the like.

However, in the traditional image capturing apparatus, the above-mentioned sensors are built-in sensors. A sound-controlling camera available in the market, for example, has only built-in audio frequency sensors therein, and the audio frequency sensors are not likely to be changed with any other sensors. Thus, different cameras with different sensors therein are needed on different automated photography conditions, which is not of the preferred economical effect.

### SUMMARY OF THE INVENTION

Nowadays there is a trend for modular product design; accordingly, the present invention provides a modular image forming apparatus with a changeable sensor therein.

The first aspect of the present invention is an image forming apparatus comprising: an interface unit outputting a control signal in a predetermined format to an output unit in accordance with a sensing signal from a sensor; an image capturing unit for capturing image; and a driving unit detachably coupled to the interface unit, wherein the driving unit having an input unit receiving the control signal for driving the image capturing unit in accordance with the control signal.

In this apparatus, a first coupling apparatus is provided in the interface unit, and a second coupling apparatus corresponding to the first coupling apparatus and detachably engaged in the first coupling apparatus is further provided in the driving unit.

The image forming apparatus of this invention further comprises a storage unit for saving the image captured as an image record in digital format.

The above-mentioned control signal comprises a impulse signal.

In addition, the sensor can be selected from the group consisting of a pressure sensor, a humidity sensor, a chemo-sensor, a timer, an audiosensor, a photoelectric cell, an ultra red sensor, and a magnetic field sensor. And, the sensor can further comprise a switch, which is given an external force to generate the sensing signal with a voltage change in the sensor. Alternatively, the sensor can comprise an image identify device, which generates the sensing signal corresponding to a result from comparing the image with a predetermined pattern.

The image capturing unit of the image forming apparatus of this invention can be a digital video camera or a digital photo camera.

The second aspect of the present invention is a signal generator for controlling an image forming apparatus, the image forming apparatus captures a control signal in a predetermined format, the signal generator comprises: a sensor generating a sensing signal in accordance with environmental variations; and an interface device detachably coupled to the image forming apparatus, the interface device generating the control signal in accordance with the sensing signal.

A coupling mechanism is provided therein for detachably engaging the image capturing apparatus, and the control signal comprises an impulse signal.

The sensor can be selected from the group consisting of a pressure sensor, a humidity sensor, a chemo-sensor, a timer, an audiosensor, a photoelectric cell, an ultra red sensor, and a magnetic field sensor. And, the sensor can further comprise a switch, which is given an external force to generate the sensing signal with a voltage change in the sensor. Alternatively, the sensor can comprise an image identify device, which generates the sensing signal corresponding to a result from comparing the image with a predetermined pattern.

The image forming apparatus of this invention has a sensor that is changeable. That is, the same image forming apparatus can be used in different environment conditions with different sensors, thus reducing device cost of automated photograph.

### BRIEF DESCRIPTION OF THE DRAWINGS

The present invention can be more fully understood by reading the subsequent detailed description in conjunction with the examples and references made to the accompanying drawings, wherein:

FIG. 1 is a diagram showing the structure according to a preferred embodiment of the invention.

### DETAILED DESCRIPTION OF THE PREFERRED EMBODIMENT

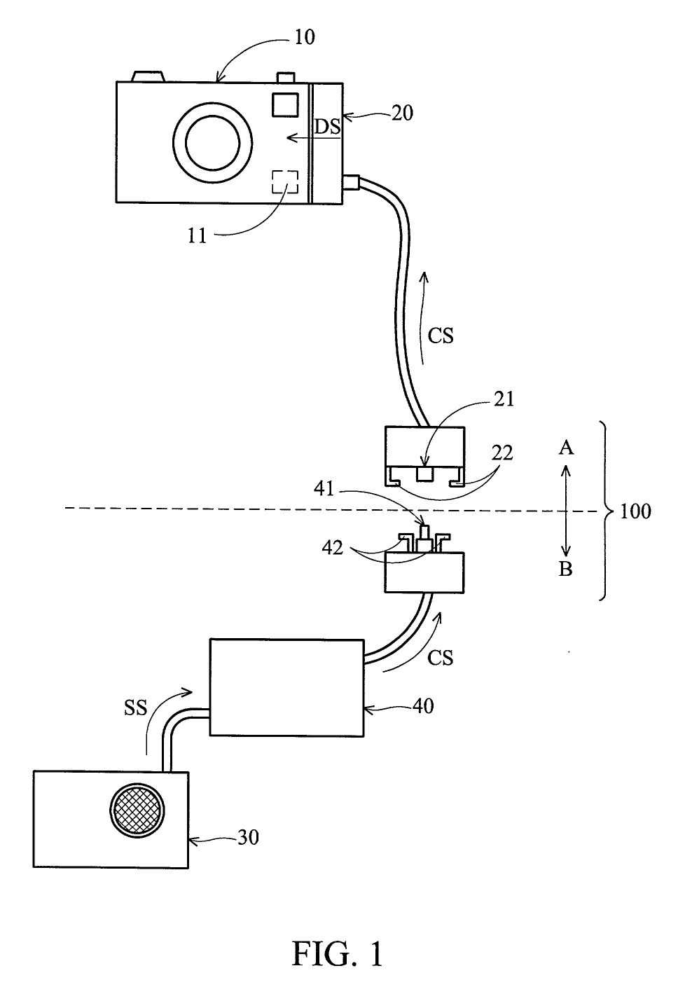

Referred to FIG. 1, an embodiment of the image forming apparatus in the present invention is an audio-controlled digital camera 100. The camera 100 in this embodiment is suited to taking photographs in accordance with sounds in environment.

The camera 100 in this embodiment comprises a camera body 10, that is an image capturing unit, for capturing image; and a driving unit 20 for driving the camera body 10, the driving unit 20 having an input unit 21 for receiving a control signal CS in a predetermined format and generating a corresponding driving signal DS to the camera body 10. The driving unit 20 is preferably provided on the camera body 10, and a first module A is thus formed with the camera body 10 and the driving unit 20.

Besides, the camera 100 in this embodiment has an audiosensor 30 for automated photograph. The audiosensor 30 is operated as follows. When receiving a sound that has a decibel value larger than a predetermined standard value, the audiosensor 30 generates a sensing signal SS.

In order to operate the camera body 10, it is necessary to deliver the sensing signal SS to the first module A. In this embodiment, an interface unit 40 is further provided to transfer the sensing signal SS to the control signal CS and output the control signal CS from the output unit 41, thus operate the first module A. In this case, if the decibel value of the sound in the environment is smaller than the standard value, the corresponding control signal CS is a DC voltage, and the first module A is in a standby state. On the other hand, if the decibel value is larger than the stand value, the corresponding control signal CS is an impulse signal (not shown in the figures), which actuate the driving unit 20 in the first module A, and the driving unit 20 controls the camera body 10 for the photograph taking operation. Preferably, the interface unit 40 and the sensor 30 can be referred to as a second module B.

This embodiment is characterized that the interface unit 40 is detachably engaged to the driving unit 20. When engaging the interface unit 40 to the driving unit 20, the output unit 41 is coupled to the input unit 21. That is, the first module A and the second module B can be detachably coupled with each other.

The interface unit 40 is preferably provided with a first coupling mechanism 42, as shown in FIG. 1. And, the driving unit 20 is preferably provided with a second coupling mechanism 22 corresponding to the first coupling mechanism 42. The second coupling mechanism 22 is detachably engaged to the first coupling mechanism 42.

As shown in the figure, the first coupling mechanism 42 and the second coupling mechanism 22 can be corresponding sticking mechanisms for providing the detachable engaging function.

The camera body 10 is provided with a storage unit 11, such as flash memory, which is similar to that in the traditional digital camera. The storage unit 11 saves the image captured as an image record. The image record can be in a specific digital format, e.g. BMP format.

It is necessary that the control signal CS generated by the interface unit 40 is of the format as described above, while the sensor 30 in the second module B is changeable. That is, various kinds of automated photograph can be performed with the first module A alternatively engaged to the second modules B with different sensors.

The sensor 30 in this embodiment is an audiosensor. However, as mentioned above, a pressure sensor, a humidity sensor, a chemo-sensor, a timer, a photoelectric cell, an ultra red sensor, a magnetic field sensor, and any other sensors that is widely-used is also applicable in this invention.

In other words, the sensor 30 can be a switch, and the switch is given an external force to generate the sensing signal with a voltage change in the sensor, and sends the sensing signal to the interface unit 40. Thus the interface unit 40 generates the control signal CS to drive the first module A.

Another embodiment of the sensor 30 in this invention is a complex device, such as an image identify device (not shown). There are various kinds of traditional image identify devices, and the image identify device in this invention, which is similar to these traditional ones, generates the sensing signal corresponding to a result from comparing the image with a predetermined pattern. Then the interface unit 40 receives the sensing signal and generates the control signal CS to drive the first module A.

The above-mentioned image capturing unit of the embodiment of this invention is a digital camera. However, the image capturing unit can be a digital video camera, or any other types of image capturing devices.

Further, the second module B can be regarded as an independent signal generator. That is, a signal generator of this invention comprises the sensor 30 and the interface device 40. Thus various signal generators with different sensors therein can be produced.

While the present invention has been described with reference to the preferred embodiments thereof, it is to be understood that the invention is not limited to the described embodiments or constructions. On the contrary, the invention is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An image forming apparatus, comprising:
an interface unit outputting a control signal in a predetermined format to an output unit in accordance with a sensing signal from a sensor;
an image capturing unit for capturing image; and
a driving unit detachably coupled to the interface unit, wherein the driving unit having an input unit receiving the control signal for driving the image capturing unit in accordance with the control signal.

2. The image forming apparatus as claimed in claim 1, wherein a first coupling apparatus is provided in the interface unit, and a second coupling apparatus corresponding to the first coupling apparatus and detachably engaged in the first coupling apparatus is further provided in the driving unit.

3. The image forming apparatus as claimed in claim 2, wherein the first coupling apparatus and the second coupling apparatus each comprises corresponding sticking structures.

4. The image forming apparatus as claimed in claim 2, further comprising a storage unit for saving the image captured as an image record.

5. The image forming apparatus as claimed in claim 4, wherein the image record is in digital format.

6. The image forming apparatus as claimed in claim 5, wherein the control signal comprises an impulse signal.

7. The image forming apparatus as claimed in claim 5, wherein the sensor is selected from the group consisting of a pressure sensor, a humidity sensor, a chemo-sensor, a timer, an audiosensor, a photoelectric cell, an ultra red sensor, and a magnetic field sensor.

8. The image forming apparatus as claimed in claim 1, wherein the sensor comprises a switch.

9. The image forming apparatus as claimed in claim 8, wherein the switch is given an external force to generate the sensing signal with a voltage change in the sensor.

10. The image forming apparatus as claimed in claim 1, wherein the sensor comprises an image identify device.

11. The image forming apparatus as claimed in claim 10, wherein the image identify device generates the sensing signal corresponding to a result from comparing the image with a predetermined pattern.

12. The image forming apparatus as claimed in claim 1, wherein the image capturing unit is a digital video camera.

13. The image forming apparatus as claimed in claim 1, wherein the image capturing unit is a digital photo camera.

14. A signal generator for controlling an image forming apparatus, the image forming apparatus captures a control signal in a predetermined format, the signal generator comprises:
a sensor generating a sensing signal in accordance with environmental variations; and
an interface device detachably coupled to the image forming apparatus, the interface device generating the control signal in accordance with the sensing signal.

15. The signal generator as claimed in claim 14, wherein the interface device is further provided with a coupling mechanism for detachably engaging the image capturing apparatus.

16. The signal generator as claimed in claim 15, wherein the coupling mechanism comprises corresponding sticking structure.

17. The signal generator as claimed in claim 14, wherein the control signal comprises an impulse signal.

18. The signal generator as claimed in claim 14, wherein the sensor is selected from the group consisting of a pressure sensor, a humidity sensor, a chemo-sensor, a timer, an audiosensor, a photoelectric cell, an ultra red sensor, and a magnetic field sensor.

19. The signal generator as claimed in claim 14, wherein the sensor comprises an image identify device.

20. The signal generator as claimed in claim 19, wherein the image identify device generates the sensing signal corresponding to a result from comparing the image with a predetermined pattern data.
